(19) United States
(12) Patent Application Publication
(10) Pub. No.: US 2017/0122357 A1
(43) Pub. Date: May 4, 2017

(54) SCREW WITH CUTTING SURFACE AT TAPERED DISTAL END THEREOF

(71) Applicant: WEN-LI HOU, Kaohsiung City (CN)

(72) Inventor: WEN-LI HOU, Kaohsiung City (CN)

(21) Appl. No.: 14/927,476

(22) Filed: Oct. 30, 2015

(51) Int. Cl. F16B 25/10

(52) U.S. Cl. CPC F16B 25/103

(57) ABSTRACT

A screw with a cutting surface at a tapered distal end thereof comprises a stem; a tapered end; a thread formed thereon; and a cutting surface cutting through the tapered end. A slope of the cutting surface with respect to an extending central axis of the stem is greater than or equal to a slope of an original surface of the tapered end with respect to the extending central axis of the stem. The cutting surface is a flat surface or a concave surface. A distal end of the cutting surface passes through or does not pass through or exactly at an extending central axis of the stem. When the tapered end drills an object, the cutting surface will cut the object rapidly, such as cements, stones, woods and the combination structures thereof. The object will not crack. The operation is easy and force-saved.

### FIELD OF THE INVENTION

The present invention relates to screws; and in particular to a screw with a cutting surface at a tapered distal end thereof.

### BACKGROUND OF THE INVENTION

To drill an object quickly, a distal end of a conventional screw is formed with a concave recess which includes two continuous walls, one is a cutting surface and another wall is adjacent thereto. The connection of two wall is formed as an acute angle. However, this design will cause dregs to be filled in the recess and finally, the dregs will affect the speed of the dregs removing. In a critical case, the screw will crack due to the filling of the dregs in the recess.

Therefore, there is an eager demand for a novel screw design which can improve the defect of the bad design of cutting recess in the conventional screws and the defect that the dregs to fill into the recess so as to cause that the speed of dreg removing is reduced and even the screw will crack.

### SUMMARY OF THE INVENTION

To improve above mentioned defects in the prior art, the present invention provides novel invention, which related to a screw with a cutting surface at a tapered distal end thereof, wherein when the tapered end drills into an object, the cutting surface at a distal end of screw will cut the object rapidly, such as cements, stones, woods and the combination structures thereof. The object will not crack. The operation is easy and force-saved.

For achieving above objects, the screw of present invention screw comprises: a stem; a tapered end; a thread formed on the stem and the tapered end; and a cutting surface cutting through the tapered end so as to form with a cutting edge with other surface of the tapered end.

Furthermore, a slope of the cutting surface with respect to an extending central axis of the stem is greater than or equal to a slope of an original surface of the tapered end with respect to the extending central axis of the stem. The cutting surface is a flat surface or a concave surface. A distal end of the cutting surface passes through or does not passes through or exactly at an extending central axis of the stem.

### BRIEF DESCRIPTION OF THE DRAWINGS:

FIG. 1 shows the first embodiment of the present invention.

FIG. 2 shows another view about the first embodiment of the present invention, in that a distal end of the screw is enlarged.

FIG. 3 is a left side view of FIG. 2.

FIG. 4 is another left side view of FIG. 2.

FIG. 5 shows the second embodiment of the present invention.

FIG. 6 shows another view about the second embodiment of the present invention, in that a distal end of the screw is enlarged.

FIG. 7 is a left side view of FIG. 6.

FIG. 8 shows the third embodiment of the present invention.

FIG. 9 shows another view about the second embodiment of the present invention, in that a distal end of the screw is enlarged.

FIG. 10 is a left side view of FIG. 9.

FIG. 11 is another left side view of FIG. 9.

FIG. 12 shows the fourth embodiment of the present invention.

FIG. 13 is a left enlarged view of FIG. 12.

FIG. 14 is another left enlarged view of FIG. 12.

### DESCRIPTION OF THE INVENTION

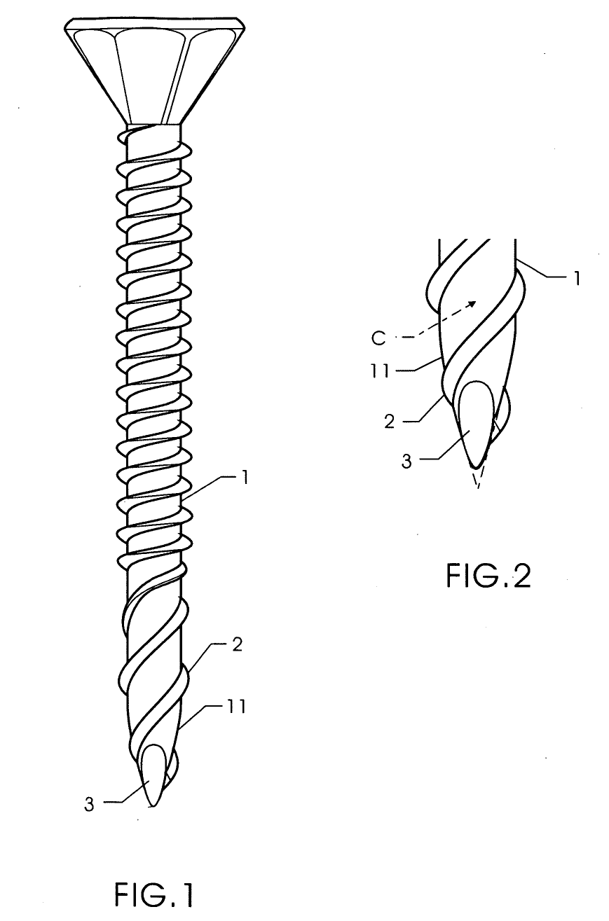

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims. Referring to FIGS. 1, 5, 8 and 12, the present invention related to a screw has stem 1 and a tapered end 11. A thread 2 is formed on the stem 1 and the tapered end 11. A cutting surface 3 cuts through the tapered end 11 so as to form with a cutting edge with other surface of the tapered end 11; and the cutting surface 3 is a flat or a concave surface. A tip distal end of the tapered end 11 is shifted from an axial of the stem 1 of the screw (the slope of the cutting surfaces with respect to an extending central axis C of the stem is greater than that of the original surface of the tapered end 11 with respective to the extending central axis C of the stem 1); or the flat cutting surface 3 is parallel to the original surface of the tapered end 11 (the slope of the cutting surfaces with respect to an extending central axis C of the stem is greater than that of the original surface of the tapered end 11 with respect to the extending central axis C of the stem 1).

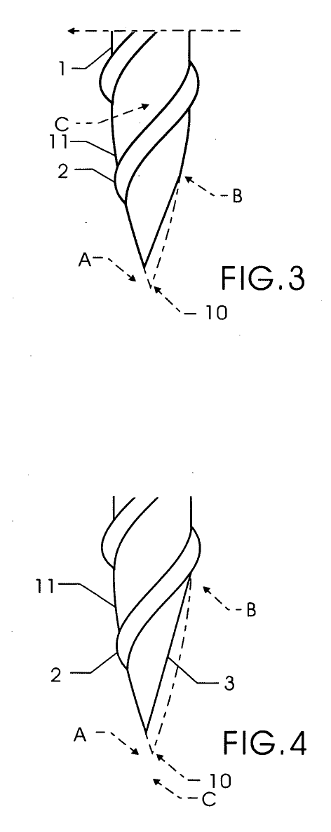

With reference to FIGS. 1 to 4, the first embodiment of the present invention is illustrated. The screw has stem 1 and a tapered end 11. A thread 2 is formed on the stem 1 and the tapered end 11. A cutting surface 3 cuts through the tapered end 11 so as to form with a cutting edge with other surface of the tapered end 11; and the cutting surface 3 is a flat surface. In this embodiment, the cutting surface 3 does not pass through the thread 2 so as to retain the completeness of the thread 2. In FIG. 3, it is illustrated that the flat cutting surface 3 is inclined to the original surface of the tapered end 11 and the tip distal end of the tapered end 11 is shifted from an axial of the stem 1 of the screw (the slope A of the cutting surface 3 with respect to an extending central axis C of the stem is larger than the slope B of the original surface of the tapered end 11 with respect to the extending central axis C of the stem 1);. In FIG. 4, it is illustrated that the flat cutting surface 3 is parallel to the original surface of the tapered end 11 (the slope A of the cutting surface 3 with respect to the extending central axis C of the stem is equal to the slope B of the original surface of the tapered end 11 with respect to the extending central axis C of the stem 1). A tip of the distal end of the tapered end 11 is shifted from the extending central C axial of the stem 1 of the screw.

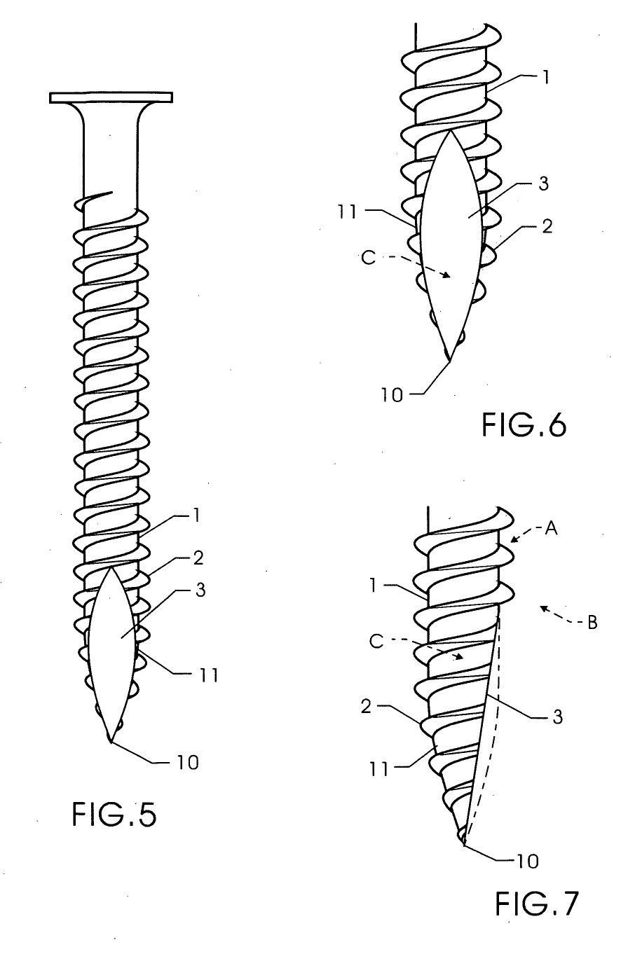

With reference to FIGS. 5 to 7, the second embodiment of the present invention is illustrated. The screw has stem 1 and a tapered end 11. A thread 2 is formed on the stem 1 and the tapered end 11. A cutting surface 3 cuts through the tapered end 11 so as to form with a cutting edge with other surfaces of the tapered end 11; and the cutting surface 3 is a flat surface. In this embodiment, the cutting surface 3 passes through the thread 2 so as to retain the completeness of the thread 2. The flat cutting surface 3 is inclined to the original surface of the tapered end 11 so that the slope A of the cutting surfaces with respect to an extending central axis C of the stem is greater than the slope B of the original surface of the tapered end 11 with respect to the extending central axis C of the stem 1; and a tip of, the distal end of the cutting surface 3 is located at the extending central axis C of the tapered end 11.

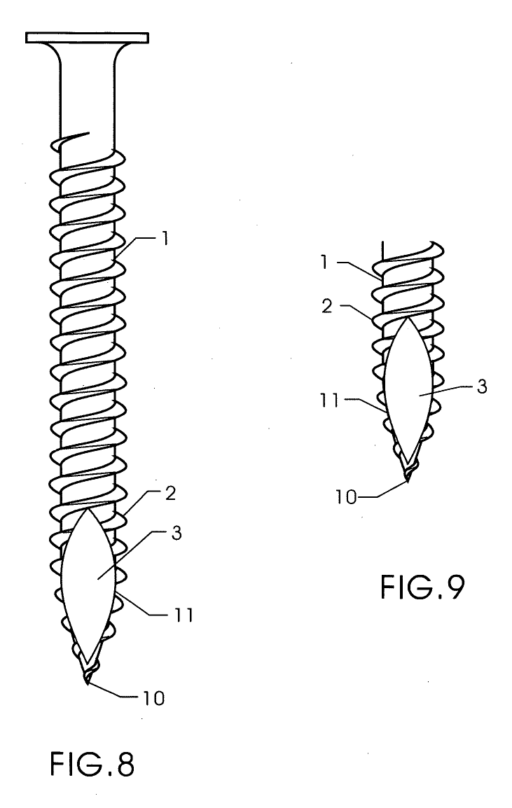

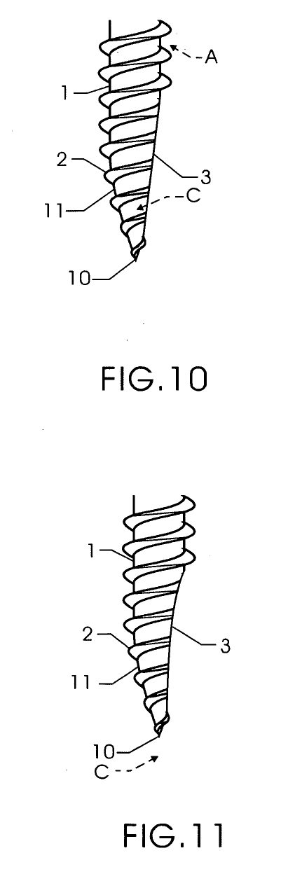

With reference to FIGS. 8 to 11, the third embodiment of the present invention is illustrated. The screw has stem 1 and a tapered end 11. A thread 2 is formed on the stem 1 and the tapered end 11. A cutting surface 3 cuts through the thread 2 on the tapered end 11 and on the stem 1 so as to form with a cutting edge with other surface of the tapered end 11 and the stem 1, while the cutting surface 3 does not pass through the center axis C of the tapered end 11. A tip of the distal end of the cutting surface 3 is located at the extending central axis C of the tapered end 11. The cutting surface 3 is a flat surface as illustrated in FIG. 10; or the cutting surface 3 is a concave surface as illustrated in FIG. 11.

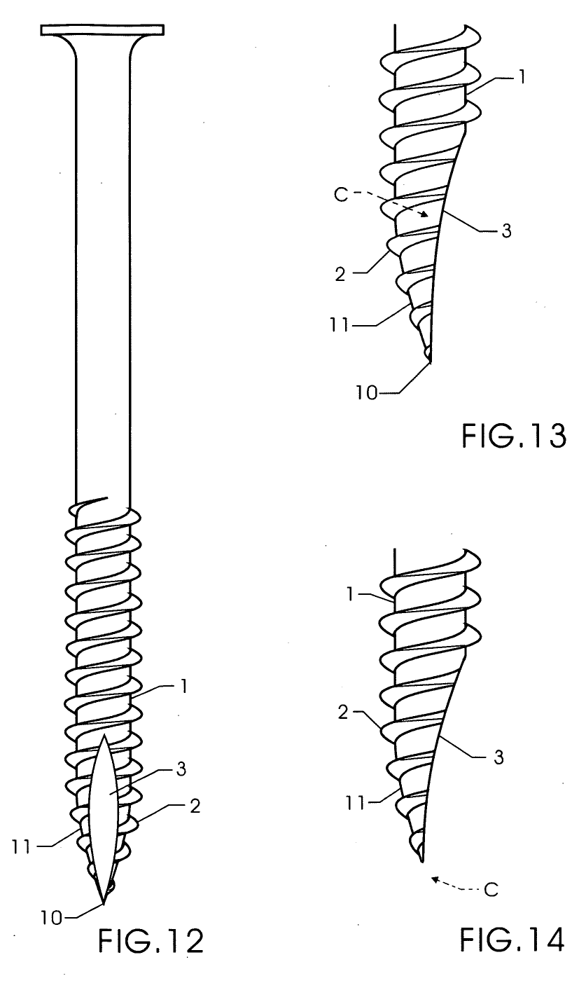

With reference to FIGS. 12 to 14, the fourth embodiment of the present invention is illustrated. The screw has stem 1 and a tapered end 11. A thread 2 is formed on the stem 1 and the tapered end 11. A cutting surface 3 cuts through the thread 2 on the tapered end 11 and on the stem 1 so as to form with a cutting edge with other surface of the tapered end 11 and the stem 1. The cutting surface 3 is a concave surface. In FIG. 13, it is illustrated that the cutting surface 3 is ended at the center axis C of the tapered end 11. In FIG. 14, it is illustrated that a distal end of the cutting surface 3 passes through the center axis C of the tapered end 11.

In the present invention, when the tapered end 11 drills into an object, the cutting surface 3 at a distal end of screw will cut the object rapidly, such as cements, stones, woods and the combination structures thereof. The object will not crack. The operation is easy and force-saved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A screw with a cutting surface at a tapered distal end thereof comprising:
a stem;
a tapered end extending from an end of the stem;
a thread formed on the stem and the tapered end; and
a cutting surface cutting through the tapered end so as to form with a cutting edge with other surface of the tapered end.

2. The screw with a cutting surface at a tapered distal end thereof as claimed in claim 1, wherein a slope of the cutting surface with respect to an extending central axis of the stem is greater than a slope of an original surface of the tapered end with respect to the extending central axis of the stem.

3. The screw with a cutting surface at a tapered distal end thereof as claimed in claim 1, wherein a slope of the cutting surface with respect to an extending central axis of the stem is equal to a slope of an original surface of the tapered end with respect to the extending central axis of the stem.

4. The screw with a cutting surface at a tapered distal end thereof as claimed in claim 1, wherein the cutting surface is a flat surface.

5. The screw with a cutting surface at a tapered distal end thereof as claimed in claim 1, wherein the cutting surface is a concave surface.

6. The screw with a cutting surface at a tapered distal end thereof as claimed in claim 1, wherein the cutting surface passes through an extending central axis of the stem.

7. The screw with a cutting surface at a tapered distal end thereof as claimed in claim 1 wherein the cutting surface does not pass through an extending central axis of the stem.

8. The screw with a cutting surface at a tapered distal end thereof as claimed in claim 1, wherein a distal end of the cutting surface is ended at an extending central axis of the stem.
